(19) United States
(12) Patent Application Publication
(10) Pub. No.: US 2008/0219889 A1
(43) Pub. Date: Sep. 11, 2008

(54) System for Automatically Processing a Biological Sample

(75) Inventors: Danny Genius Aldegonda Schaefer, Eindhoven (NL); Adrianus Wihelmus Dionisius Maria Van Den Bijgaart, Eindhoven (NL); Michiel De Jong, Eindhoven (NL); Ronald Cornelis De Gier, Eindhoven (NL); Jacobus Frederik Molenaar, Utrecht (NL); Ralph Theodorus Hubertus Maessen, Eindhoven (NL); Roger Maria Helmut Godfried Wehrens, Eindhoven (NL); Peter Hermanus Bouma, Eindhoven (NL); Chris Van Haag, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/064,082

(22) PCT Filed: Aug. 11, 2006
(86) PCT No.: PCT/IB2006/052782

§ 371 Date: Feb. 19, 2008

(30) Foreign Application Priority Data
Aug. 19, 2005 (EP) 05107623.0

(51) Int. Cl. B01J 19/00; B01L 11/00; G01N 1/00

(52) U.S. Cl. 422/68.1; 422/99; 422/103; 73/863

(57) ABSTRACT

The invention provides a system, a processing apparatus, a sample unit, a reagent unit and a method for processing a biological sample in the inside of the sample unit. The system comprises at least a processing apparatus and a sample unit, the sample unit comprises a plurality of microfluidic elements, the processing apparatus comprises actuation means capable of actuating at the microfluidic elements such that a quick, cheap and accurate analysis of the biological sample is possible.

The present invention relates to a system for automatically processing a biological sample comprising a processing apparatus and a sample unit. The present invention further relates to a system for automatically processing a biological sample comprising a processing apparatus, a sample unit and a reagent unit. The present invention further relates to a processing apparatus, a sample unit and a reagent unit provided to be used together with the system according to the present invention. The present invention further relates to a method for processing a biological sample by the system according to the present invention.

In the field of biological sample analysis, especially molecular diagnostic as well as nucleic acid analysis, and in particular analysis by isolation of nucleic acid from a biological or clinical specimen, there exists a need for an enhanced degree of automation because, e.g. the isolation of nucleic acid from biological samples can be time-consuming and tedious and many manual steps may introduce errors due to, e.g. contamination. Sample preparation might include cell isolation, cell lysis and washing. For genetic analysis regarding genetic-based disease, conditions or characteristics, it is essential to have available a reliable, easily reproduced method of nucleic acid isolation, particularly one that is amenable to automation. This requirement is particularly useful for detection of specific bacterial DNA in low concentrations in a body fluid of a patient.

In U.S. Pat. No. 6,811,668 B1, a system for operation or handling of a laboratory microchip for chemical processing or analysis is disclosed aiming at an enhanced integration of stationary laboratory installation into portable systems and thus an enhanced miniaturization.

Prior art systems usually do not provide for a low-cost, efficient and rapid sample treatment with only little and in any case only standardized manual interference.

It is an object of the present invention to provide a system for automated, time-efficient, accurate and low-cost processing of a biological sample by means of disposable sample cartridges or sample cassettes or sample units.

The above object is achieved by a system, a processing apparatus, a sample unit, a reagent unit and a method according to the present invention. The present invention offers an integrated system in which all chemical and/or biological process steps from taking the sample until assay detection are performed inside one cartridge (system-in-package). The cartridge or sample unit is inserted in an instrument that takes care of the various actuations and eliminates manual labour steps. This gives the results much sooner and with higher repeatability. Therefore, such a system is more user-friendly and avoids the risk of cross-contamination because all processes are carried out in a closed disposable cartridge.

In a first aspect of the present invention, a system for automatically processing a biological sample is disclosed, wherein the system comprises a processing apparatus or instrument and a sample unit or cartridge, wherein the sample unit comprises a plurality of microfluidic elements, wherein the processing apparatus comprises actuation means capable of actuating at least partially the microfluidic elements and wherein the sample unit is provided as a passive unit. Such a passive sample unit can be made e.g. of relatively inexpensive plastic materials such that the overall cost for processing an individual sample is very low. The main feature of such a passive sample unit or cartridge is that it is actuated externally, i.e. by the processing apparatus. Therefore, the processing apparatus comprises a slot or region where the sample unit can be placed. The processing apparatus is then able to actuate the sample unit, i.e. the cartridge, in order to process the biological sample inside the sample unit. As the sample unit is provided as a passive sample unit, it can be manufactured very inexpensively. In the context of the present invention, the term “passive unit” is to be understood to mean that the structure of the sample unit does not comprise any active elements in the sense that active elements are performing operations of transformation of e.g. electrical work into mechanical work or the like. Of course, the sample unit is provided to process the sample, i.e. any biological or chemical material to be analyzed, and therefore comprises channels or conduits, reservoirs and valves to direct a fluid flow into one of various channels or conduits, but such valves (for example) inside the sample unit are purely passively actuated by the processing apparatus. It is also to be understood that the sample unit can contain besides the sample (e.g. a liquid taken out of the body of a patient or the like) further liquid, gaseous or solid materials needed during the processing of the sample, e.g. buffer liquids and the like.

In a further aspect of the present invention, a system for automatically processing a biological sample is disclosed, wherein the system comprises a processing apparatus or instrument and a sample unit or cartridge, wherein the sample unit comprises a plurality of microfluidic elements, wherein the processing apparatus comprises actuation means capable of actuating at least partially the microfluidic elements and wherein the system further comprises a reagent unit provided to be coupled to the sample unit. Such a reagent unit carries e.g. sensitive reagents necessary for the processing of the biological sample, such as PCR (polymerase chain reaction) mastermix reagents that can be easily degraded.

An advantage of the system according to the invention is that the reagent unit can be stored in defined conditions, e.g. within a special temperature environment or the like, whereas the sample unit can be stored wherever samples have to be taken, especially in a hospital near the patient. Thereby, the handling of the sample unit and of the reagent unit is easier and therefore less expensive.

The reagent unit can be coupled to the sample unit before introducing both units into one or several slots or regions of the processing apparatus. Alternatively the reagent unit is introduced separately into a slot or region of the processing apparatus and the coupling or joining of the sample unit to the reagent unit is performed inside the processing apparatus and by the processing apparatus. This last alternative has the advantage that the coupling operation of the reagent unit and the sample unit is performed automatically leading to less errors than a coupling step to be performed manually.

In a preferred embodiment of the present invention, the sample unit is provided as a disposable sample unit and/or the reagent unit is provided as a disposable reagent unit. An advantage thereof is that it is thereby possible that the handling of the inventive system is even more easy and inexpensive because especially labor costs, e.g. in recycling the sample unit and/or the reagent unit, can be saved.

In a further preferred embodiment of the present invention, the actuation means are capable of applying to the sample unit an actuation interaction based on at least one of a mechanical force, an electrical force, an electrical current, a magnetic force, a radiation interaction or a thermal interaction. E.g. it is possible that the actuation means apply a mechanical force by a pusher to a specific region of the sample unit in order to actuate a valve inside the sample unit. Furthermore, it is possible that the actuation means moves a magnet close to the sample unit in order to apply a magnetic force on the sample unit and especially on the entire content of the sample unit or a part of that content. If, according to one embodiment of the present invention, a reagent unit is present in the inventive system, it is also preferred that the actuation means are capable of applying to the sample unit and/or the reagent unit an actuation interaction based on at least one of a mechanical force, an electrical force, an electrical current, a magnetic force, a radiation interaction or a thermal interaction.

An advantage thereof is that the sample unit and/or the reagent unit and especially the contents of these units can undergo various transformations in order to process the biological sample in an effective, accurate and reproducible manner.

In still a further preferred embodiment of the present invention, the microfluidic elements are actuated at least partially by the actuation interaction. For example, by applying a mechanical force to a plunger, it is possible to direct a fluid into a fluid chamber of the sample unit or of the reagent unit e.g. into a mixing chamber or a reaction chamber. An advantage of the system according to the invention is that it is possible to control the biochemical reactions inside the sample unit by means of the actuation interaction of the processing apparatus.

In a preferred embodiment of the present invention, the microfluidic elements comprise at least a mixing chamber, a channel and a valve. Other microfluidic elements can also be present in the sample unit, such as reaction chambers or the like. An advantage of the system according to the invention is that it is possible to perform all necessary steps for conducting an analysis or a biochemical assay only in the interior of the sample unit or in the interior of the combination of the sample unit and the reagent unit.

In a preferred embodiment of the present invention, the sample unit comprises a sample identification means and the processing apparatus comprises a sample identifying means. An advantage of the system according to the invention is that it is possible to identify the patient, the sample processing operator and the cartridge series and type in an unambiguous manner.

The present invention also includes a processing apparatus provided to be used in a system according to the present invention. In a preferred embodiment of the present invention such a processing apparatus comprises a thermocycling means able to apply to the sample unit or at least to a part of the sample unit a changing temperature environment adapted to perform a special reaction, e.g. a PCR reaction (polymerase chain reaction). An advantage of the processing apparatus according to the invention is that it is possible to perform even such complicated biological assays as PCR-based nucleic acid detection.

The present invention also includes a sample unit provided to be used in a system according to the present invention. Such a sample unit can be provided in a very easy and cost-effective way. It is therefore possible to perform all the biological process steps in a defined way such that neither a contamination of the environment by the sample unit nor a contamination of the sample unit by the environment occurs.

The present invention also includes a reagent unit provided to be used in a system according to the present invention. Such a reagent unit can also be provided in a very easy and cost-effective way. According to the invention, it is therefore possible to standardize and to simplify the process of analyzing biological samples by e.g. providing a comparatively small number of different reagent units for processing a multitude of different biological samples.

The present invention also includes a method for processing a biological sample by a system, the system comprising a processing apparatus and a sample unit, the sample unit comprising at least a mixing chamber, a channel and a valve as a plurality of microfluidic elements, the processing apparatus comprising actuation means capable of actuating at least partially the microfluidic elements, wherein the sample unit is provided as a passive sample unit, wherein in a first step the sample is introduced into the sample unit, wherein in a second step the sample unit is coupled to the processing apparatus, and wherein in a third step the sample is processed in the interior of the sample unit. An advantage of the method according to the invention is that it is possible to perform biochemical analysis, e.g. immunoassays or nucleic acid assays, very quickly, easily and cost-effectively.

In a preferred embodiment of the present invention, the sample unit is coupled to the reagent unit before the third step of the inventive method. The coupling of the reagent unit to the sample unit can occur either inside the processing apparatus or outside the processing apparatus, i.e. both units are jointly introduced into the processing apparatus. By means of a reagent unit, it is advantageously possible to store the reagent unit and the sample unit independently and more cost-effectively.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference signs quoted below refer to the attached drawings.

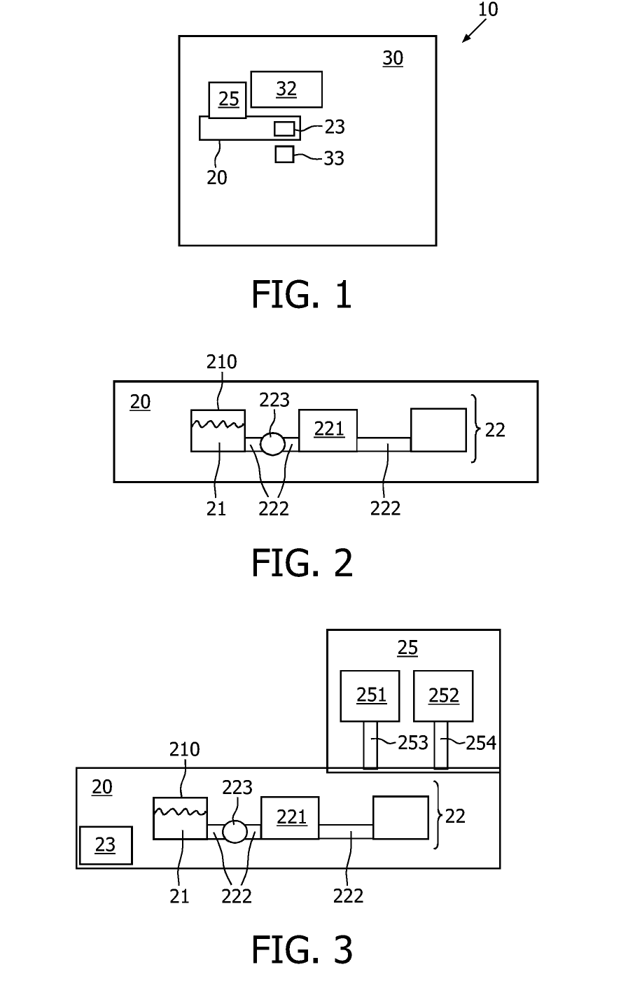

FIG. 1 illustrates schematically a system for automatically processing a biological sample according to the present invention.

FIG. 2 illustrates schematically a sample unit according to the present invention.

FIG. 3 illustrates schematically a sample unit coupled to a reagent unit according to the present invention.

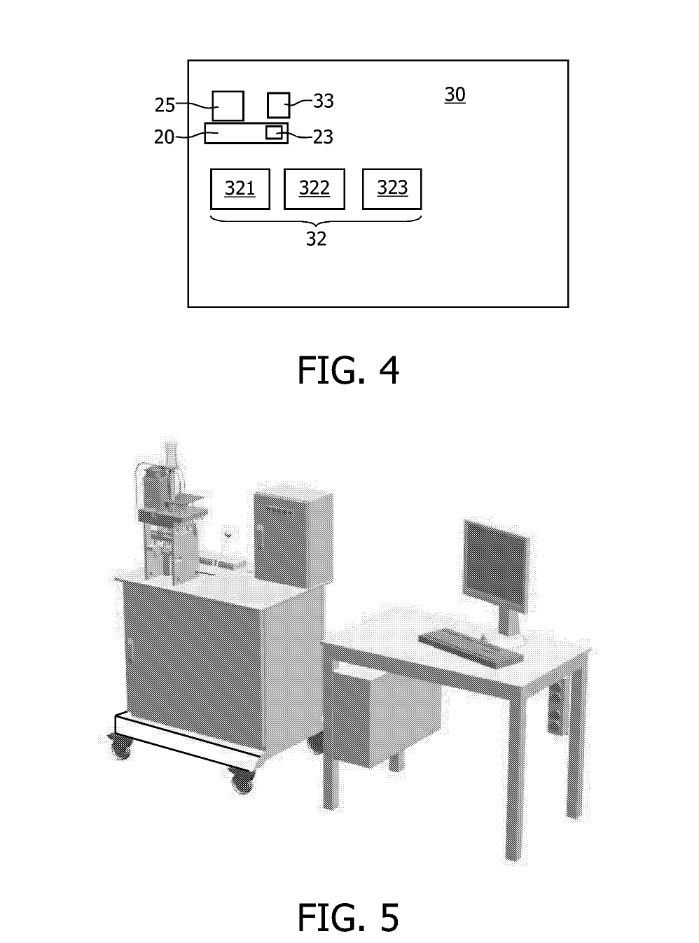

FIG. 4 illustrates schematically the processing apparatus according to the present invention in more detail.

FIG. 5 illustrates a perspective view of a processing apparatus according to the present invention.

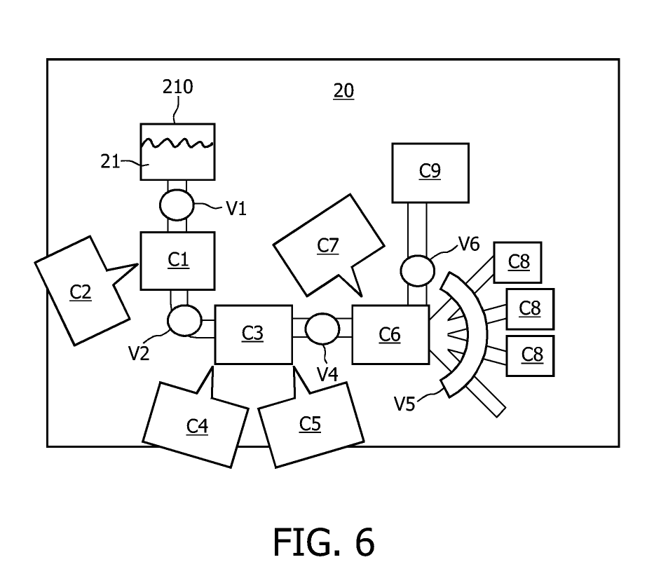

FIG. 6 illustrates schematically a top view of one example of a sample unit.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes.

Where an indefinite or definite article is used when referring to a singular noun, e.g. “a”, “an”, “the”, this includes a plural of that noun unless specifically stated otherwise.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noted that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that, with respect to the present invention, the only relevant components of the device are A and B.

FIG. 1 illustrates schematically a system 10 for automatically processing a biological sample according to the present invention. The sample is located inside a sample unit 20 and the sample unit 20 is located inside a processing apparatus 30, hereinafter also called instrument 30. The sample unit 20 can be inserted into or taken out of the processing apparatus 30, e.g. by means of a slot or other geometrical feature and/or by means of a drive mechanism. The insertion or loading of the sample unit 20 (which is in the following also called sample cartridge 20) into the processing apparatus 30 is, according to the present invention, unambiguous and preferably carried out manually. For the manual loading of the sample unit 20, preferably alignment slides are used. Of course, according to the present invention, it is also possible to load the sample unit 20 automatically into the processing apparatus 30, e.g. out of a stack of a plurality of sample units 20. The sample unit 20 is provided with a sample identification means 23 and the processing apparatus 30 is provide with a sample identifying means 33. The sample identification means 23 and the sample identifying means 33 correspond to each other in that they are able to interact with each other. For example, the sample identification means 23 can be provided as a barcode, a transponder ID tag or the like. For example, the sample identifying means 33 can be provided as a barcode reader, transponder ID tag counterpart or the like. The processing apparatus 30 further comprises actuation means 32 able to interact with the sample unit 20. According to one embodiment of the invention, the system 30 also comprises a reagent unit 25. The reagent unit 25 can be coupled to the sample unit 20. Preferably, the reagent unit 25 also comprises identification means, i.e. reagent identification means, not shown in FIG. 1 for the sake of simplicity. Accordingly in this case, either the processing apparatus 30 comprises further identifying means adapted to interact with the reagent identification means (neither shown in FIG. 1) or the identifying means 33 are also able to interact with the reagent identification means.

FIG. 2 illustrates schematically a sample unit 20 according to the present invention. For the sake of simplicity, the sample identification means are not shown in FIG. 2. The sample unit 20 is shown after a sample 21, especially a liquid or especially containing a liquid, has been introduced into the sample unit 20. The sample unit 20 is therefore provided with a sample chamber 210. Besides the sample chamber 210, the sample unit 20 comprises a plurality of microfluidic elements, jointly denoted by reference sign 22. As examples of such microfluidic elements 22, a mixing chamber 221, a plurality of channels 222 or conduits 222 and a valve 223 is shown.

FIG. 3 illustrates schematically a sample unit 20 coupled to a reagent unit 25 according to one embodiment of the present invention. The sample unit 20 comprises the identification means 23, the sample chamber 210, the sample 21, the microfluidic elements 22 (for example: mixing chamber 221, channels 222 or conduits 222 and valve 223). The reagent unit 25 comprises a first reagent chamber 251 and a second reagent chamber 252 as well as a first reagent conduit 253 and a second reagent conduit 254. The first reagent chamber 251, the second reagent chamber 252, the first reagent conduit 253 and the second reagent conduit 254 are examples of microfluidic elements inside the reagent unit 25. Of course, it is also possible that the reagent unit 25 comprises only one reagent within one reagent chamber. Also, the reagent unit 25 can comprise only one reagent within a plurality of reagent chambers. According to the present invention, it is preferred that the reagent unit comprises a plurality of reagents in a plurality of separated reagent chambers. By means of the reagent conduits 253, 254 or by means of other microfluidic elements such as valves or the like, it is possible to actively transport or to passively release the reagents at least partly from the reagent unit 25 to the sample unit 20 for use in the biological processing taking place preferably in the sample unit 20.

FIG. 4 illustrates schematically the processing apparatus 30 according to the present invention in more detail. The processing apparatus 30 comprises the sample unit 20, the reagent unit 25, the identification means 23, the identifying means 33 and the actuation means 32, wherein in the example of FIG. 4, the actuation means 32 are depicted as comprising three different embodiments of actuation means 32, namely a mixing actuator 321, a transporting actuator 322 and a valve actuator 323. The mixing actuator 321 is for example a mechanical actuator applying mechanical forces to the structure of the sample unit 20 such that liquids in an appropriately located mixing chamber are mixed with each other. Especially, the sample unit 20 can comprise a mixing rod interfacing with the mixing actuator 321 of the processing apparatus 30. The mixing actuator 321 applies an eccentric rotative coupling. The processing apparatus 30 therefore comprises a rotative, preferably electrical, motor. The mixing actuator 321 can also be provided in the form of an electromagnetic actuator applying electromagnetic forces either to the structure of the sample unit 20 or directly to the content of an appropriately located mixing chamber. The transporting actuator 322 can for example be provided as a mechanical means able to move a plunger (not shown) inside the sample unit 20 or inside the reagent unit 25 in order to transport a fluid (reagent or sample fluid, etc.) out of an appropriately located chamber through a channel or conduit to a location inside the sample unit 20 or inside the reagent unit 25 where the fluid is needed. The transporting actuator 322 can also be provided by means of a pressure-applying means where the plunger of for example a membrane is moved by a pressurized fluid. The valve actuator 323 can for example be provided as another mechanical or electrical element applying a mechanical force to the structure of the sample unit 20 in order to open or close a valve located inside the sample unit 20. For example, the valve actuator 323 can be implemented by pushing on a certain lever that is part of the sample unit and opens the valves. According to the invention, there are preferably also rotating valves inside the sample unit 20. An example of such rotating valves is the so-called PCR disk. These valves of the PCR disk are opened simultaneously by rotating the PCR disk. The actuation for rotating the PCR disk (only by a small angle) is preferably made by a stepping motor and a push/pull cable for opening and closing the PCR disk.

For dosing the various reagents, the sample unit 20 and/or the reagent unit 25 have some reservoirs or chambers that are filled with these reagents. These reservoirs are emptied via the instrument 30 preferably via linear stepping motors. Coupled to the tip of such a linear stepping motor is a push/pull cable that allows for flexible mounting and positioning. The push/pull cable is pushed into the reservoirs or chambers where a plunger is located. It is the movement of this plunger that causes the reagent in the reservoir to exit. This principle is used in all cases where a reservoir needs to be emptied.

On some locations of the sample unit, especially on reservoirs or chambers, heating is required. This is done, for example, by moving a sleeve (not shown) over the reservoir. The sleeve comprises a coil which heats the reservoir. Of course, it is also possible according to the present invention to provide a heating means in a configuration other than a sleeve, e.g. heating by radiation or the like.

Pressure is applied to the sample unit 20 by means of a pneumatic cabinet that is part of the instrument 30. This cabinet consists of pressure regulators, a mini-compressor, pneumatic valves etc. The actual interface on the sample unit 20 can be for example in the form of a flexible nozzle that is pushed against the bottom of the disposable sample unit 20, which contains a hole.

FIG. 5 illustrates a perspective view of a system according to the present invention. As can be seen from the figure, the system according to the present invention can also comprise a PC or workstation controlling the details of the biological processes and the actions and actuations taken by the processing apparatus 30. Especially according to any of the embodiments of the present invention, the PC or workstation can comprise a graphical user interface for defining the biological processing or the assay, for obtaining quick access to test data and for ease of working with the assay results and interpretations of these results.

In FIG. 6, a top view of an example of a sample unit is schematically illustrated. In this example, the processing of a biological sample for the case of a PCR-based assay type is described in more detail. In the example, the sample is a blood sample of a human or non-human being and the biological assay is a PCR-based nucleic acid assay. The graphical user interface serves, according to the present invention, especially to define the assay to be processed inside the sample unit 20 (i.e. definition of the lysis step, the washing steps, the individual PCR thermocycling steps and the detection cycle). After definition of the assay, the assay can be started preferably via the graphical user interface and the results will be stored automatically on a PC disk, on a network or on another suitable location or device. Alternatively, it is also possible according to the present invention, that the identification means 23 contains or points to the information needed to define the assay. In this case, the graphical user interface is only needed e.g. for controlling the progression of the assay.

At the beginning of processing the sample 21, the liquid of the sample 21 is located in the sample chamber 210. In one preferred embodiment of the invention, the liquid of the sample 21 is transferred to a first chamber C1. Between the sample chamber 210 and the first chamber C1, there is preferably provided a first valve V1 which is opened when the liquid of the sample 21 is transferred to the first chamber C1. Either before or during or after the transfer of the sample 21 to the first chamber C1, the processing apparatus 30 or instrument 30 adds the correct amount of lysis buffer to the blood sample 21. This means that, from a second chamber C2 where the lysis buffer is stored (either in the sample unit 20 or in the reagent unit 25), the lysis buffer is transported inside the sample unit 20 or out of the reagent unit 25 towards the sample unit 20 to the location where the lysis buffer is provided to be mixed with the sample 21, e.g. in the sample chamber 210 or in the first chamber C1. The location where the lysis buffer is mixed with the sample 21 will furthermore also be called the mixing chamber 221. Either the sample chamber 210 or the first chamber C1 or another chamber (not depicted) can serve as mixing chamber 221.

The instrument 30 interfaces with a structure of the sample unit 20 called a mixing rod (not depicted). By moving the mixing rod, a movement in the liquid contained in the mixing chamber 221 is induced such that a mixing takes place.

After the lysis process is finished, the instrument 30 applies a certain pressure under the appropriate lysis process chamber (e.g. the mixing chamber 221/first chamber C1), thereby forcing the mixture to leave the lysis process chamber and to move toward a further process chamber which is in the example given a washing chamber C3. There is a second valve V2 between the lysis process chamber (mixing chamber 221 or first chamber C1) and the washing chamber C3 which is actively opened by the instrument 30 by means of the valve actuator 323.

The instrument is able to subsequently empty various washing reservoirs containing the magnetic beads needed to isolate DNA or the nucleic acids, and the other washing reagents. The washing reservoirs are also called fourth chamber C4 and fifth chamber C5 and can be located either inside the sample unit 20 or inside the reagent unit 25. In a further alternative embodiment, the fourth and fifth chamber C4, C5 can be located partly in the sample unit 20 and partly in the reagent unit 25. The fourth and fifth chambers C4, C5 are only examples of reservoirs containing reagents and/or magnetic beads and/or other sorts of labels used in conducting the assay. Of course, it is possible that only one reservoir containing only one single sort of labels or reagents is released into the washing chamber C3, but according to the invention it is preferred that a plurality of reagents and/or labels are released into the washing chamber C3, be it out of one single reservoir (containing the plurality of reagents and/or labels) or out of a plurality of reservoirs (containing each one compound of particle out of the plurality of reagents and/or labels).

In a preferred embodiment, the instrument 30 subsequently heats up the contents of an elution buffer (stored in another reservoir not shown in FIG. 6) to a specific temperature. Also the contents of this preheated elution reservoir are emptied via the actuators of the instrument 30. In an alternative embodiment of the present invention, the elution buffer is not heated but simply added to the contents of the washing chamber C3.

For proper washing, the instrument 30 actuates two permanent magnets (not shown). One is located just above the washing chamber C3 in the sample unit 20, the other just below it. The instrument 30 takes care of the rotation of the magnets and also a certain vertical movement to withdraw the magnets from the process chamber or washing chamber C3. The upper magnet additionally can be stopped in a predefined position near the sample unit 20 for magnetic bead trapping.

By applying pressure under the washing chamber C3, the DNA eluate is pumped—preferably through a conduit containing a fourth valve V4—into a PCR mixing chamber C6. Also in this case, the fourth valve V4 between the washing chamber C3 and the PCR mixing chamber C6 is actively opened by the instrument 30 by means of an appropriate valve actuator 323.

The instrument 30 empties the contents of a PCR mastermix capsule C7 or reservoir C7 (or also a plurality of reservoirs) located either inside the sample unit 20 or inside the reagent unit 25.

Together with the DNA eluate as the result of the previous washing step, the PCR mastermix is mixed in the PCR mixing chamber C6 in the same way as the lysis mixing is effected.

After the PCR mixing is complete, the instrument 30 opens a plurality of, e.g. ten, entry points to a number of, e.g. ten, individual PCR chambers C8 via a rotating valve V5, also called PCR disk V5.

By applying pressure under the PCR mixing chamber C6, the contents of this chamber will be divided over the individual PCR chambers C8. When all the individual chambers C8 are filled, the instrument 30 closes the entry points by rotating the PCR disk V5.

Then, in the example of a biological assay, the PCR thermocycling is started inside the individual PCR chambers C8 via the instrument 30. For that purpose, copper elements are located just above the individual PCR chambers C8. By actively heating and cooling the copper elements (e.g. via Peltier elements or another heating and cooling device) the contents of the PCR chambers C8 are heated and cooled.

When the thermocycling is finished, the instrument 30 opens the individual PCR chambers C8 by rotating the PCR disk V5 and applies pressure above every individual PCR chamber C8, which procedure empties the contents of every PCR chamber C8.

When all amplicons are mixed together again in the PCR mixing chamber C6, pressure is applied under the PCR mixing chamber C6 after actively opening a sixth valve V6 between the PCR mixing chamber C6 and a detection cell C9. All amplicons are thereby transported into the detection cell or ninth chamber C9.

The liquid with the amplicons is then pumped through a porous membrane (not shown in FIG. 6). The instrument 30 applies a pressure above the sample containing part of the sample unit 20, especially the detection cell C9, such that it is pumped through the membrane.

After this pump cycle, the instrument 30 will further proceed the sample 21 by a detection step. For example, this detection step is executed by taking an image of the porous membrane to visualize any hybridization of at least parts of amplicons with corresponding parts. Imaging is carried out by illuminating the membrane via a light source, e.g. via a LED, and detection of the emitted light of fluorescent labels, also called the fluorophores, on the membrane is carried out e.g. via a CCD camera.

After this detection step, especially an imaging step, the liquid containing the amplicons is pumped back above the membrane again. This cycle is repeated several times (as defined by the definition of the assay, e.g. by means of the graphical user interface). During this pumping, the instrument also heats up the entire detection cell C9 to prevent any unspecific binding.

The software on the instrument 30 or on the PC or workstation associated with the instrument 30 takes care of logging all process parameters during the assay and also places the output images on a defined location of the PC disk or another storage medium.

Once the assay has been processed, the instrument 30 ejects the sample unit 20 and/or the reagent unit 25 and the instrument 30 can be used for another assay.

1. A system (10) for automatically processing a biological sample (21), the system comprising a processing apparatus (30) and a sample unit (20), the sample unit (20) comprising a plurality of microfluidic elements (22), the processing apparatus (30) comprising actuation means (32) capable of actuating at least partially the microfluidic elements (22), wherein the sample unit (20) is provided as a passive sample unit (20).

2. A system (10) for automatically processing a biological sample (21), the system (10) comprising a processing apparatus (30) and a sample unit (20),
the sample unit (20) comprising a plurality of microfluidic elements (22),
the processing apparatus (30) comprising actuation means (32) capable of actuating at least partially the microfluidic elements (22), wherein the system (10) further comprises a reagent unit (25) provided to be coupled to the sample unit (20).

3. A system (10) as claimed in claim 1, wherein the sample unit (20) is provided as a disposable sample unit (20).

4. A system (10) as claimed in claim 2, wherein the sample unit (20) is provided as a disposable sample unit (20) and/or wherein the reagent unit (25) is provided as a disposable reagent unit (25).

5. A system (10) as claimed in claim 1, wherein the actuation means (32) are capable of applying to the sample unit (20) an actuation interaction based on at least one of a mechanical force, an electrical force, an electrical current, a magnetic force, a radiation interaction or a thermal interaction.

6. A system (10) as claimed in claim 2, wherein the actuation means (32) are capable of applying to the sample unit (20) and/or the reagent unit (25) an actuation interaction based on at least one of a mechanical force, an electrical force, an electrical current, a magnetic force or a radiation interaction.

7. A system (10) as claimed in claim 5, wherein the microfluidic elements (22) are actuated at least partially by the actuation interaction.

8. A system (10) as claimed in claim 1, wherein the microfluidic elements (22) comprise at least a mixing chamber, a channel and a valve.

9. A system (10) as claimed in claim 1, wherein the sample unit (20) comprises a sample identification means (23) and wherein the processing apparatus comprises a sample identifying means (33).

10. A processing apparatus (30) provided to be used in a system (10) as claimed in claim 1.

11. A processing apparatus (30) as claimed in claim 10, wherein the processing apparatus (30) comprises a thermocycling means.

12. A processing apparatus (30) as claimed in claim 10, wherein the processing apparatus (30) comprises a detection means.

13. A sample unit (20) provided to be used in a system (10) as claimed in claim 1.

14. A sample unit (20) provided to be used in a system (10) as claimed in claim 2.

15. A reagent unit (25) provided to be used in a system (10) as claimed in claim 2.

16. A method for processing a biological sample (21) by a system, the system comprising a processing apparatus (30) and a sample unit (20),
the sample unit (20) comprising at least a mixing chamber, a channel and a valve as a plurality of microfluidic elements (22),
the processing apparatus (30) comprising actuation means (32) capable of actuating at least partially the microfluidic elements (22), wherein the sample unit (20) is provided as a passive sample unit (20),
wherein in a first step the sample (21) is introduced into the sample unit,
wherein in a second step the sample unit (20) is coupled to the processing apparatus (30), and
wherein in a third step the sample is processed in the interior of the sample unit (20).

17. A method as claimed in claim 16, wherein the sample unit (20) is coupled to a reagent unit (25) before the third step.
